(19) United States
(12) Patent Application Publication
(10) Pub. No.: US 2013/0175942 A1
(43) Pub. Date: Jul. 11, 2013

(54) VOLTAGE MULTIPLIER CIRCUIT

(71) Applicant: Jean-Francois MAINGUET, Grenoble (FR)

(72) Inventor: Jean-Francois MAINGUET, Grenoble (FR)

(73) Assignee: COMMISSARIAT A L'ENERGIE ATOMIQUE ET AUX ENE ALT, Paris (FR)

(21) Appl. No.: 13/542,939

(22) Filed: Jul. 6, 2012

(30) Foreign Application Priority Data
Jul. 8, 2011 (FR) 11 56236

(51) Int. Cl. G05F 1/46; H05B 37/02

(52) U.S. Cl. CPC G05F 1/46; H05B 37/02
USPC 315/228; 323/364; 307/31

(57) ABSTRACT

A multiplier circuit for a voltage Vdc applied to a first input of the circuit, comprising:
a first capacitor and a second capacitor;
a coupler that in a first state, can electrically couple a first terminal of each capacitor to a zero electrical potential and a second terminal of each capacitor to an electrical potential equal to Vdc, and in a second state can electrically couple the first terminal of the first capacitor to the electrical potential Vdc, the second terminal of the second capacitor to the zero electrical potential, the second terminal of the first capacitor to a first output terminal and the first terminal of the second capacitor to a second output terminal;
a controller capable of controlling the change from one state to another.

### TECHNICAL FIELD

The invention relates to a voltage multiplier circuit, for example used to provide an electrical power supply to one or several LEDs (Light Emitting Diodes) from an input voltage less than a threshold voltage of the LED(s).

The voltage multiplier circuit is advantageously used to make one or several LEDs flash.

### STATE OF PRIOR ART

A problem that sometimes arises is the need to supply electrical power to a load, for example a LED, from a voltage that is insufficient to correctly supply power to the load continuously. For example, the threshold voltage to light a LED is relatively high (about 1.6 V for a red LED, about 3 V for a blue LED and even 3.5 V for some high luminosity white LEDs).

The current that passes through the LED depends on the voltage applied at its terminals and the resulting luminosity is approximately linear to the injected current when the voltage at its terminals exceeds its threshold voltage. Thus, a photovoltaic cell that usually outputs a voltage equal to 0.7 V is not sufficient by itself to power a LED satisfactorily.

One known technique for increasing the value of a voltage is to use switched capacitor circuits. A multi-vibrator is used to vary the voltage at the terminals of the capacitor. If it is required to obtain an output voltage of more than twice the input voltage, then several switched capacitors have to be arranged in cascade.

In this case, losses at the diodes located between the capacitors become very high. Furthermore, such a cascade works very badly at low voltage because phase signals have to be generated. Finally, saturation phenomena also disturb operation of such a system.

Another known means of increasing the value of a voltage is to use “boost converter” or “step-up converter” circuits that conventionally use an inductance and a multi-vibrator to operate. The problem with this type of circuit is efficiency, which does not become attractive (for example about 70%) until the current consumption is high.

At very low consumption (as is the case for the electrical power supply for a LED), this type of circuits is not efficient because not only is the efficiency low, but the circuit also consumes a high current (for example of the order of about 1 mA) at no load.

### PRESENTATION OF THE INVENTION

Thus there is a need to provide a voltage multiplier circuit increasing the input voltage by a factor of about 3, for example to power an electric load such as a LED, from a low input voltage for example less than the threshold voltage of the LED, consuming less current than circuits according to prior art, that is inexpensive to make and that is compact.

For this purpose, one embodiment of the invention discloses a multiplier circuit for a voltage Vdc intended to be applied to at least one first input of the circuit, comprising at least:
a first capacitor and a second capacitor capable of storing electrical charges;
coupling means, or a coupler, capable of electrically coupling, in a first state, a first terminal of each capacitor to a zero electrical potential and a second terminal of each capacitor to an electrical potential equal to Vdc, and capable of electrically coupling, in a second state, the first terminal of the first capacitor to the electrical potential Vdc, the second terminal of the second capacitor to the zero electrical potential, the second terminal of the first capacitor to a first output terminal of the circuit, and the first terminal of the second capacitor to a second output terminal of the circuit;
controlling means, or a controller, capable of controlling the change from one state corresponding to the first or the second state, to another state corresponding to the second or first state respectively.

It is also disclosed a multiplier circuit for a voltage Vdc intended to be applied to at least one first input of the circuit, comprising at least:
a first capacitor and a second capacitor capable of storing electrical charges;
coupling means, or a coupler, that in a first state, can electrically couple a first terminal of each capacitor to a zero electrical potential and a second terminal of each capacitor to an electrical potential equal to Vdc, and in a second state can electrically couple the first terminal of the first capacitor to the electrical potential Vdc, the second terminal of the second capacitor to the zero electrical potential, the second terminal of the first capacitor to a first output terminal of the circuit and the first terminal of the second capacitor to a second output terminal of the circuit;
a second input to which a control signal is intended to be applied controlling the change from one state corresponding to the first or the second state, to another state corresponding to the second or first state respectively.

In this document, the term “coupled” or “coupling” have to be understood as corresponding to a connection which can be direct between the two coupled elements, but also which can be indirect, that is comprising one or several elements or components between the two coupled elements (e.g. with a resistor or any other components between the two coupled elements).

In a first phase corresponding to the first state, this multiplier circuit electrically charges the capacitors using the input voltage Vdc, and then in a second phase corresponding to the second state, uses the capacitor charge pump phenomenon such that the load (for example a LED) “sees” a voltage equal to approximately 3 Vdc between its terminals. By repeating these two phases, a LED can thus be made to flash at a very low frequency, consuming the minimum energy possible particularly due to the lack of any inductance in this circuit.

The multiplier circuit can apply a voltage in the form of a “flash” to the terminals of the load, in other words for a short period, which is sufficient to illuminate a LED for a time corresponding to the time for the voltage to drop under the LED threshold voltage.

The circuit according to the invention may for example be used to light a LED that normally requires a voltage equal to 3 V to emit light, from a power supply source that outputs a voltage Vdc equal to about 1 V.

The circuit may advantageously function with a voltage Vdc between about 0.8 V and 1.8 V.

The electrical coupling means, or the coupler, may comprise:
a first connection means, or first connector, capable of electrically coupling, in the first state, the first terminal of the first capacitor to the zero electrical potential, or in the second state, to the electrical potential Vdc;
a second connection means, or second connector, capable of electrically coupling, in the first state, the second terminal of the first capacitor to the electrical potential Vdc, or in the second state, to the first output terminal;
a third connection means, or third connector, capable of electrically coupling, in the first state, the first terminal of the second capacitor to the zero electrical potential, or in the second state, to the second output terminal;
a fourth connection means, or fourth connector, capable of electrically coupling, in the first state, the second terminal of the second capacitor to the electrical potential Vdc, or in the second state, to the zero electrical potential.

Each of the first, second, third and fourth connection means, or connectors, may comprise at least one switch or a CMOS inverter. Furthermore, each of the first, second, third and fourth connection means, or connectors, may be made with MOS transistors.

The controlling means, or controller, may comprise a second input of the circuit intended to receive a control signal.

The first connection means, or first connector, may comprise a CMOS inverter intended to be electrically powered by the voltage Vdc, the second input of the circuit may be electrically coupled to an input of said CMOS inverter and an output of said CMOS inverter may be electrically coupled to the first terminal of the first capacitor.

In this case, the second and the third connection means, or connectors, may each comprise a switch intended to be controlled by a signal outputted on the output of the CMOS inverter output of the first connection means, or first connector.

The fourth connection means, or fourth connector, may comprise a CMOS inverter intended to be electrically powered by the voltage Vdc, the first terminal of the first capacitor may be electrically coupled to an input of the CMOS inverter of the fourth connection means, or fourth connector, and an output of the CMOS inverter of the fourth connection means, or fourth connector, may be electrically coupled to the second terminal of the second capacitor.

The second connection means, or second connector, may comprise a CMOS inverter comprising at least two MOS transistors, the sources of which may be electrically coupled to the electrical potential Vdc and to the first output terminal of the circuit, the second terminal of the first capacitor may be electrically coupled to an output of the CMOS inverter of the second connection means, or second connector, and the first terminal of the first capacitor may be electrically coupled to an input of the CMOS inverter of the second connection means, or second connector.

The third connection means, or third connector, may comprise a CMOS inverter comprising at least two MOS transistors, the sources of which may be electrically coupled to the zero electrical potential and to the second output terminal of the circuit, the first terminal of the second capacitor may be electrically coupled to an output of the CMOS inverter of the third connection means, or third connector, and the second terminal of the second capacitor may be electrically coupled to an input of the CMOS inverter of the third connection means, or third connector.

The coupling means and the controlling means, or the coupler and the controller, may comprise:
a microcontroller capable of electrically coupling, in a first state, the first terminal of the first capacitor to the zero electrical potential, or in the second state, to the electrical potential Vdc, and capable of electrically coupling, in the first state, the second terminal of the second capacitor to the electrical potential Vdc, or in the second state, to the zero electrical potential;
at least one electrical load intended to be electrically powered by a voltage outputted between the first and the second output terminal of the multiplier circuit and having a threshold voltage intended to be less than the voltage Vdc;
a first electrical resistor electrically coupled between the electrical potential Vdc and the first output terminal of the multiplier circuit;
a second electrical resistor electrically coupled between the second output terminal of the multiplier circuit and the zero electrical potential.

The invention also relates to an electronic device comprising at least:
a multiplier circuit like that defined above;
at least one electrical load intended to be electrically powered by a voltage outputted between the first and the second output terminal of the multiplier circuit.

The electrical load may comprise at least one LED. In this case, the voltage outputted from the multiplier circuit may be greater than the threshold voltage of the LED.

The device may also comprise:
electrical power supply means, or electrical power supply, capable of generating an electrical voltage Vdc on an output;
second controlling means, or a second controller, capable of generating a control signal oscillating between two distinct values on an output;

and in which the first input of the multiplier circuit may be electrically coupled to the output of the electrical power supply, and in which the controlling means, or controller, for example the second input, of the multiplier circuit may be electrically coupled to the output of the second controlling means, or the second controller.

The electrical power supply may comprise photovoltaic energy conversion means, or photovoltaic energy converter, coupled to at least one capacitor capable of storing energy outputted by the conversion means, or the photovoltaic energy converter, and supplying the electrical voltage Vdc to the terminals of said capacitor. Such power supply enables the device to be completely self-contained without requiring any maintenance (for example no battery replacement). The photovoltaic energy conversion means, or convertor, and the converted energy storage capacitor form an energy accumulation system which has the particular advantage over an electrochemical battery that it avoids fast degradation of energy storage performances with time (the storage capacitor can be efficient for at least a million cycles, unlike the case of a battery for which the performances usually degrade after about a thousand cycles), and there is no need to monitor voltages and the electrical charge carried out (monitoring to avoid overcharges and deep discharges in the case of a battery).

The converted energy storage capacitor may have a capacitance of more than about 0.1 Farad. The main advantage of such a capacitance is that it occupies a very small volume (usually about 1 cm³ per Farad). The photovoltaic energy conversion means may comprise at least one photovoltaic cell, or one or several PIN diodes instead of the photovoltaic cell that are very compact (a few mm²).

In one variant, the electrical power supply may comprise at least one battery. In another variant, the electrical power supply means may comprise at least one capacitor capable of storing electrical charges outputted from the control signal.

The second controlling means, or second controller, may comprise at least one oscillator or multi-vibrator, and may be coupled to the electrical power supply and to the multiplier circuit.

The electrical load may comprise a plurality of LEDs and at least one multiplexer capable of alternately coupling each LED with the first and second output terminals of the multiplier circuit.

In this case, the multiplexer may be coupled to at least one binary counter capable of controlling coupling between a plurality of LEDs and either the first or the second output terminal of the multiplier circuit. It is thus possible to make a running light lighting the different LEDs one after the other.

The invention also relates to a process for multiplying a Vdc voltage comprising at least the following steps:

a) coupling, or application, of a zero electrical potential to a first terminal of each of the first and second capacitors capable of storing electrical charges, and an electrical potential equal to Vdc to a second terminal of each of the two capacitors, electrically charging the first capacitor and the second capacitor and then

b) application of the electrical potential Vdc to the first terminal of the first capacitor and a zero electrical potential to the second terminal of the second capacitor, an output voltage corresponding to the multiplied voltage Vdc being retrieved between the second terminal of the first capacitor and the first terminal of the second capacitor.

Steps a) and b) may be repeated successively, the output voltage possibly being applied to the terminals of at least one LED.

### BRIEF DESCRIPTION OF THE DRAWINGS

This invention will be better understood after reading the description of example embodiments given purely for information and that are in no way limitative with reference to the appended drawings in which:

FIGS. 1 to 4 show different embodiments of a voltage multiplier circuit according to this invention;

FIG. 5 diagrammatically shows an electronic device according to this invention, comprising a voltage multiplier circuit also according to this invention;

FIGS. 6, 7A and 7B show example embodiments of elements of the electronic device shown in FIG. 5;

FIGS. 8 to 11 show electronic devices according to this invention, comprising a voltage multiplier circuit also according to this invention;

FIG. 12 shows a voltage multiplier circuit according to another embodiment of the invention.

Identical, similar or equivalent parts of the different figures described below are assigned the same numeric references to facilitate comparison between the different figures.

The different parts shown in the figures are not necessarily all at the same scale to make the figures more easily readable.

The different possibilities (variants and embodiments) must be seen as not being mutually exclusive and as being possibly combined with each other.

### DETAILED PRESENTATION OF PARTICULAR EMBODIMENTS

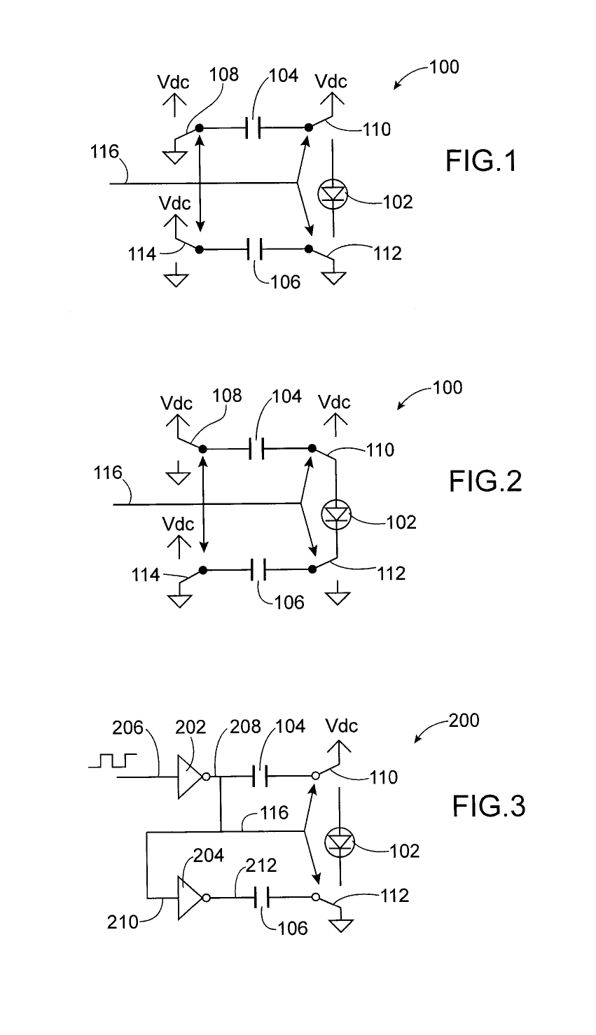

Firstly refer to FIGS. 1 and 2 that show a voltage multiplier circuit 100 according to a first embodiment. In this case the circuit 100 operates like a symmetric charge pump capable of approximately tripling the value of a power supply voltage Vdc and applying this voltage equal to about 3.Vdc to the terminals of a load 102, in this case a LED.

The circuit 100 comprises two capacitors 104 and 106, and four electrical coupling means, or connection means or connectors, in this case corresponding to switches 108, 110, 112 and 114 simultaneously switching from a first state corresponding to a charge phase of the capacitors (state shown in FIG. 1), to a second state corresponding to a discharge phase of the capacitors 104 and 106 in the LED 102 (state shown in FIG. 2). The four switches are controlled by controlling means, or a controller, her corresponding to a single control signal 116 applied on an input of the circuit 100 and oscillating between two values, for example between 0 and +Vdc. When the switches 108, 110, 112 and 114 are adapted to be controlled by a signal with a different value, the voltage multiplier circuit 100 may comprise means of adapting the value of the control signal as a function of the value intended to be received by the switches 108, 110, 112 and 114. The control signal 116 may for example be a square signal.

The first capacitor 104 comprises a first terminal or end electrically coupled to a first switch 108, and a second terminal electrically coupled to a second switch 110. The second capacitor 106 comprises a first terminal electrically coupled to a third switch 112 and a second terminal electrically coupled to a fourth switch 114.

During the charge phase of the capacitors 104 and 106, the four switches 108, 110, 112 and 114 are in a switching state such that the capacitors 104 and 106 each have their first terminal electrically coupled to the electrical potential Vdc and their second terminal electrically coupled to a zero electrical potential such as the ground.

When the four switches 108, 110, 112 and 114 change to the second switching state corresponding to the capacitor discharge phase (FIG. 2) simultaneously, the first terminal of the first capacitor 104 coupled to the first switch 108 changes from a zero potential to the potential +Vdc, and the second end of the first capacitor 104 coupled to the second switch 110 is then coupled to a first terminal of the LED 102. The second terminal of the second capacitor 106 coupled to the fourth switch 114 changes from a potential equal to +Vdc to a zero potential, and the first terminal of the second capacitor 106 is coupled to a second terminal of the LED 102.

Thus, when the switches 108, 110, 112 and 114 change from the first state shown in FIG. 1 to the second state shown in FIG. 2, and due to the charge pump phenomenon, a potential equal to +2.Vdc (+Vdc potential on the first terminal of the first capacitor 104+potential +Vdc between the two terminals of the first capacitor 104) is applied to the first terminal of the LED 102 (that coupled to the second switch 110) and a potential equal to −Vdc (corresponding to the potential between the two terminals of the second capacitor 106) is applied to the second terminal of the LED 102 (that coupled to the third switch 112). Thus, immediately after the switches 108, 110, 112 and 114 change from the first state to the second state, a voltage equal to three times the power supply voltage Vdc is applied to the terminals of the LED 102. The voltage of 3.Vdc is greater than the threshold voltage of the LED 102 (which may be between approximately 1.5 V and 3.5 V depending on the colour of the LED 102), and the LED 102 then becomes electrically conducting and the capacitors 104 and 106 discharge through the LED 102 until the potential at the terminals of the LED 102 drops below its threshold voltage. During this discharge, the LED 102 is electrically powered and emits light radiation with a duration corresponding to the discharge duration of the capacitors 104 and 106 until the threshold voltage of the LED 102 is reached.

After the voltage at the terminals of the LED 102 has dropped below the threshold voltage of the LED 102, the switches 108, 110, 112 and 114 change back to the first state in which the capacitors 104 and 106 can be recharged and the 1^{st} state-2^{nd} state cycle is repeated so that the LED 102 flashes.

The durations of the charge and discharge phases of the capacitors 104 and 106, in other words the durations of the states in which the switches 108, 110, 112 and 114 are, will depend on the frequency of the control signal 116. This control signal may for example be a square signal with a frequency equal to about 0.5 Hz. In this case, the duration of each phase is equal to about 1 second.

The voltage multiplier circuit 100 is capable of providing a sufficient voltage to the LED 102 to illuminate the LED 102 for a certain period, which enables a “flash” of light to be emitted through the LED, the duration of which depends on the values of the capacitors 104, 106 and the equivalent resistance of the LED 102, starting from a voltage Vdc for example equal to about 1 volt, for a red LED for which the threshold voltage is equal to about 1.6 V and for a blue LED for which the threshold voltage is equal to about 3 V, or a white LED for which the threshold voltage is approximately 3.5 V, with excellent energy efficiency because if the capacitors 104 and 106 could not discharge completely, the charge is kept for the next charge-discharge cycle of the capacitors 104 and 106.

For example, the values of the capacitors 104 and 106 may be between about 1 μF and 10 μF, for example depending on the required effect (power of LED 102). For capacitors 104 and 106 with values equal to about 10 μF and a LED with equivalent resistance equal to about 100Ω, the duration of the flash of the LED 102 is equal to about 1 ms (τ=RC).

The four switches 108, 110, 112 and 114 with simultaneous control, that is the coupling means, or the coupler, of the circuit 100, may be made as a single component, for example corresponding to circuit TS3A44159 made by Texas Instruments (which operates from a voltage equal to about 1.65 V) or circuit ADG734 made by Analogue Devices (that operates from about 1.8V). The value of the voltage Vdc may be adapted to correspond to the minimum voltage above which the component forming the four switches 108, 110, 112 and 114 will function.

The switches 108, 110, 112 and 114 are preferably of the “break-before-make” type, in other words during a change from a first state to a second state, the electrical connection formed during the first state is open before the change which makes the electrical connection of the second state, which prevents unexpected short circuits that can increase consumption of the multiplier circuit 100.

FIG. 3 shows a voltage multiplier circuit 200 according to a second embodiment. Like the circuit 100 described above, the multiplier circuit 200 forms a symmetric charge pump capable of tripling the value of a power supply voltage Vdc and applying this triple voltage to the terminals of the LED 102.

Compared with circuit 100, the first and the fourth switches 108 and 114 are replaced by two CMOS type inverters 202 and 204 powered by the voltage +Vdc. The first inverter 202 comprises an input 206 (coupled to the gates of the two NMOS and PMOS transistors forming the inverter 202) on which the square control signal for which the value changes from 0 to +Vdc is applied. The first inverter 202 comprises an output 208 (coupled to the drains of the two MOS transistors in the inverter 202) electrically coupled to the first terminal of the first capacitor 104 and to an input 210 of the second inverter 204 (corresponding to the gates of the two NMOS and PMOS transistors in the second inverter 204). An output 212 of the second inverter 204 (electrically coupled to the drains of the two MOS transistors in the second inverter 204) is electrically coupled to the second end of the second capacitor 106. The control signal 116 controlling switching of the second and third switches 110 and 114 corresponds to the signal outputted from the first inverter 202, and therefore corresponds to the signal that is the inverse of the signal applied to the input 206 of the first inverter 202. The inverters 202 and 204 are powered at voltage Vdc.

When the value of the signal applied to the input 206 of the first inverter 202 is equal to +Vdc, this first inverter outputs a signal with zero potential on its output 208, this zero potential therefore being applied to the first terminal of the first capacitor 104. The second switch 110 then connects the second terminal of the first capacitor 104 to the +Vdc potential. This zero potential signal is also applied to the input 210 of the second inverter 204. Therefore the second inverter 204 outputs a signal with a potential equal to +Vdc on its output 212, this potential being applied to the second terminal of the second capacitor 106. The third switch 112 connects the first end of the second capacitor 106 to the ground.

Thus, when the signal applied to the input 206 of the first inverter 202 is equal to a value +Vdc, the circuit 200 is in a configuration similar to the first state described above with reference to FIG. 1, in other words it is in a state in which the capacitors 104 and 106 are charged.

When the signal applied to the input 206 of the first inverter 202 changes value to become zero, the first inverter outputs a signal with a potential equal to +Vdc on its output 208, therefore this potential +Vdc being applied to the first terminal of the first capacitor 104. The signal outputted from the first inverter 202 that corresponds to the control signal 116 changes the switches 110 and 112 to their second switching state, then electrically coupling the second terminal of the first capacitor 104 and the first terminal of the second capacitor 106 to the terminals of the LED 102. This signal with potential +Vdc is also applied to the input 210 of the second inverter 204. Therefore the second inverter 204 outputs a signal with a zero potential on its output 212, this potential being applied to the second end of the second capacitor 106.

Thus, when the value of the signal applied to the input 206 of the first inverter 202 is zero, the circuit 200 is in a configuration similar to the second state previously described with reference to FIG. 2, in other words it is in a state in which the capacitors 104 and 106 are discharging into LED 102, a voltage equal to +3.Vdc being applied to the terminals of the LED 102 when changing from the first to the second state.

Like the switches 110 and 112, the inverters 202 and 204 preferably have a “break-before-make” type property such that there is a time shift in sending control signals to N and P MOSs. This time shift may be obtained using several inverters or capacitors, capable of shifting these signals in time.

In one variant, it is possible that only one of the switches 108 or 114 may be replaced by a CMOS inverter.

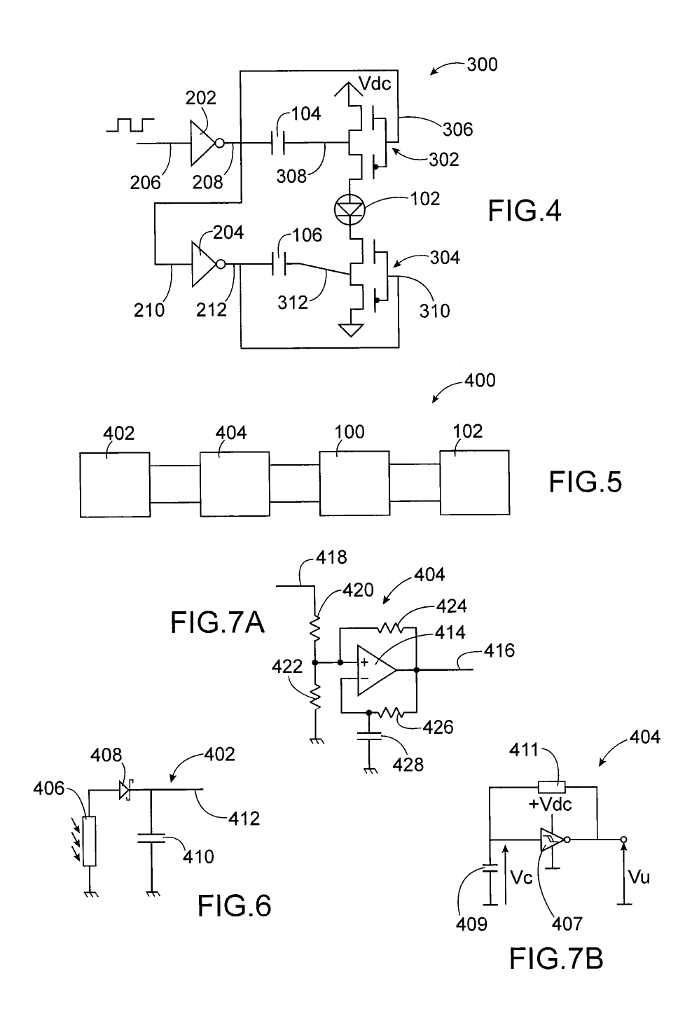

FIG. 4 shows a voltage multiplier circuit 300 according to a third embodiment.

Like the circuits 100 and 200 described above, the circuit 300 forms a symmetric charge pump capable of tripling the value of the power supply voltage Vdc applied to the input of the circuit 300.

Compared with the circuit 200, the second and third switches 110 and 112 have been replaced by two CMOS inverters 302 and 304, called the third and fourth inverters. The third and fourth inverters 302 and 304 are powered differently from the first and second inverters 202, 204 (that are powered conventionally between the ground and the potential +Vdc). The output 208 of the first inverter 202 is electrically coupled to an input 306 of the third inverter 302, in other words it is electrically coupled to the gates of the two NMOS and PMOS transistors of the third inverter 302. The voltage +Vdc is applied to the source of the NMOS transistor of the third inverter 302 and the source of the PMOS transistor of the third inverter 302 is electrically coupled to one of the terminals of the LED 102. An output 308 of the third inverter 302 (coupled to the drains of the two MOS transistors in the third inverter 302) is electrically coupled to the second end of the first capacitor 104. The output 212 of the second inverter 204 is electrically coupled to an input 310 of the fourth inverter 304, in other words it is electrically coupled to the gates of the two NMOS and PMOS transistors of the fourth inverter 304. The source of the PMOS transistor of the fourth inverter 304 is coupled to the ground and the source of the NMOS transistor of the fourth inverter 304 is electrically coupled to the other terminal of the LED 102. An output 312 of the fourth inverter 304 (coupled to the drains of the two MOS transistors of the fourth inverter 304) is electrically coupled to the first end of the second capacitor 106.

Operation of the circuit 300 is similar to operation of the previous circuits 100 and 200, the change in the value of the signal applied to the input 206 of the first inverter 202 changing the circuit 300 from one switching state to the other, charging and discharging the capacitors 104 and 106 successively, a voltage equal to +3.Vdc being applied to the terminals of the LED 102 when changing from the first to the second state.

As before, the CMOS inverters 302 and 304 may have a “break-before-make” type property.

The different inverters may be replaced by MOSFETs performing switching from one state to the other as described above in the circuit.

In one variant, it is possible that only one of the switches 110 and 112 is replaced by a MOS inverter. Furthermore, one or the two CMOS inverters 202 and 204 may be replaced by one or the two switches 104 and 114.

In all embodiments described above (circuits 100, 200 and 300), the power supply voltage applied to the terminals of the capacitors 104 and 106 during the charging phase of capacitors 104 and 106 may be limited for example by inserting a resistor between the second switch 110, or the third inverter 302, and the power supply potential +Vdc, and a resistor between the fourth switch 114, or the second inverter 204, and the power supply potential +Vdc. These resistors can limit the charge current of the capacitors 104, 106 and prevent sudden voltage drops in the voltage multiplier circuit, related to excessive current inrush on the voltage source at the time of switching.

FIG. 5 shows an electronic device 400 comprising the voltage multiplier circuit 100 coupled to the LED 102. The device 400 also comprises a power supply 402 outputting the voltage Vdc, electrically coupled to the control means, or controller, 404 capable of outputting a control signal oscillating between two distinct values, for example corresponding to an oscillator or a multi-vibrator, outputting the control signal 116 to the voltage multiplier circuit 100. In other variants, the voltage multiplier circuit 100 may be replaced by one of the previously described circuits 200 or 300.

FIG. 6 shows an example embodiment of power supply means 402. This power supply 402 comprises a photovoltaic cell 406, for example of the amorphous type, one terminal of which is electrically coupled to a Schottky diode 408 itself electrically coupled to a storage capacitor 410 for example equal to about 0.2 F, the value of which may be greater than about 0.1 F. The photovoltaic cell 406 outputting a voltage for example between about 3 V and 5 V thus charges the storage capacitor 410 through the Schottky diode 408 that prevents a current leak from the storage capacitor 410 to the photovoltaic cell 406 when the photovoltaic cell no longer outputs a current (when it is no longer lit). The voltage Vdc is supplied on an output 412 from the electrical power supply 402. The internal resistance of the storage capacitor 410, of the order of a few hundred mr), is not a problem because the consumption of the device 400 in current is much less than about 1 mA, which is equivalent to a few hundred kΩ under load.

FIG. 7A shows an example embodiment of the means 404, that is the controller 404, in this case in the form of an oscillator. The oscillator comprises an operational amplifier 414, for example type LPV7215, which outputs a square signal at a frequency of about 0.5 Hz on an output 416 of the oscillator.

The operational amplifier 414 is powered by the voltage Vdc and is also coupled to the ground. Such a square signal can make the LED 102 flash about once every two seconds. The oscillator comprises an input 418 onto which the voltage +Vdc is applied. This input 418 is electrically coupled in series to two resistors 420 and 422, for example equal to about 10 MΩ. The positive input of the operational amplifier 414 is coupled to the link between the two resistors 420 and 422. The output 416 is electrically coupled to the positive input of the operational amplifier 414 through a resistor 424 for example with a value equal to about 22MΩ. The output 416 is also electrically coupled to the negative input of the operational amplifier 414 through a resistor 426, for example with a value equal to about 10 MΩ. A capacitor 428, for example equal to about 470 nF, links the negative input of the operational amplifier 414 to the ground.

As a variant, the oscillator may be made from components different from those shown in FIG. 7A, for example using two inverters.

As an alternative to the oscillator, the means or controller 404 may be made in the form of a multi-vibrator with a Schmitt trigger, an example embodiment of which is shown in FIG. 7B. This multi-vibrator comprises a Schmitt trigger 407 for which one input is coupled to a capacitor 409 and comprising a retroaction loop between its input and its output, a resistor 411 being placed on this retroaction loop.

The advantage of such a multi-vibrator compared with the oscillator shown in FIG. 7A, is that it outputs an oscillating signal from a power supply voltage (for example equal to about 0.8 V) lower than that from which the oscillator outputs an oscillating signal. On the other hand, such a multi-vibrator consumes more current than the oscillator from a voltage equal to about 1.6 V. Furthermore, the frequency of the signal outputted by the multi-vibrator depends on the value of the input voltage, unlike the oscillator that outputs an oscillating signal for which the frequency is less dependent on the value of the input voltage.

The capacitors 104 and 106 used in the device 400 may for example each have a value of 1 μF. Furthermore, in the example described herein, resistors have been inserted in the voltage multiplier circuit 100 between the power supply potential +Vdc and the switches 110 and 114.

For a voltage equal to about 2V at the terminals of the LED 102, the consumption of the circuit 100 is between about 5 μA and 7 μA which can give good light flashes of the LED 102.

Considering that the circuit 100 operates above about 1.6 V, and charging the storage capacitor 410 to about 3 V gives an operating voltage equal to about 1.4 V. We know that:

Q=t·I=CV

where I is the current outputted by the storage capacitor 410, in A;

C is the value of the storage capacitor 410, in F;

V is the voltage at the terminals of the storage capacitor 410, in V.

Therefore, we have the time t=1.4*0.2/10.10⁻⁶, namely t=7.7 hours (after rounding the consumption to an average of 10 μA over the entire voltage range applied to the LED 102). The device 400 can thus make the LED 102 flash for an entire night, the storage capacitor 410 having been charged by the photovoltaic cell 406 during the day. The value of the storage capacitor 410 is chosen according to particularly the required operating time of the device 400 when the electrical power supply 402 no longer supplies any voltage or current.

The size of the photovoltaic cell 406 depends on the required lighting.

Thus, for indoors operation of the device 400, the photovoltaic cell 406 may be a large amorphous type cell, while for outdoors operation of the device 400, the photovoltaic cell 406 may be a small monocrystalline cell.

The consumption of the flashing part of the device 400 (LED 102+voltage multiplier circuit 100) is equal to about 10 μA at 0.5 Hz, which is slightly less than 1 Coulomb over 24 hours. If the device 400 is to operate all night (when the photovoltaic cell 406 stops outputting current), the electrical power supply of the device 400 will require a capacitor of about 0.5 Farad, or even less if the voltage outputted at the terminals of the storage capacitor 410 is for example more than about 1.5 V, for example between about 1.5 V and 3 V. This can be achieved by sizing the photovoltaic cell 406 so that it is capable of collecting a few tens of microamperes, for example between about 30 μA and 50 μA at 3 volts (i.e. at least 90 μW) for 8 hours, under poor lighting conditions for example inside the house where the light flux received by the cell 406 may be between about 100 and 200 lux, which is possible with an amorphous photovoltaic cell with an active surface area of between about 1 and 2 cm², composed of 4 to 8 energy conversion elements. In the case in which the device 400 is used outdoors in sunshine (light flux between about 50000 and 100000 lux), the same amorphous cell generates a current of several mA so that the same result can be obtained with a charging time of the storage capacitor 410 of the order of 16 minutes. If the efficiency of the cell 406 is about 15%, a surface area of about 1 mm² would be sufficient (for example obtained by putting several PIN type photodiodes used as photovoltaic conversion elements in series).

The oscillator or the multi-vibrator and the voltage multiplier circuit 100, 200 or 300 may be made in the form of a specific integrated circuit intended to be assembled with the LED 102 and the electrical power supply 402 on a single support.

As a variant, the device 400 may also comprise means capable of triggering and stopping flashing of the LED 102, for example so that it only operates at night, or using a presence or movement detector. For example, it is possible that these means detect when current generation by the photovoltaic cell 406 stops, and trigger flashing of the LED 102 starting from this moment.

In another variant not shown, the device 400 may comprise a conventional voltage step-up device placed between the electrical power supply source (for example the photovoltaic cell 406) and the storage capacitor 410. Such a voltage step-up device can increase the voltage at the terminals of the storage capacitor 410 and therefore the energy stored in the storage capacitor 410, within the limit that the storage capacitor 410 can resist, for example equal to 5V.

The electrical power supply 402 may comprise a conventional battery instead of the photovoltaic cell coupled to a storage capacitor.

The type of battery to be used is chosen as a function of its life duration, cost, etc. Such a battery may be an AA type battery or a lithium button type battery.

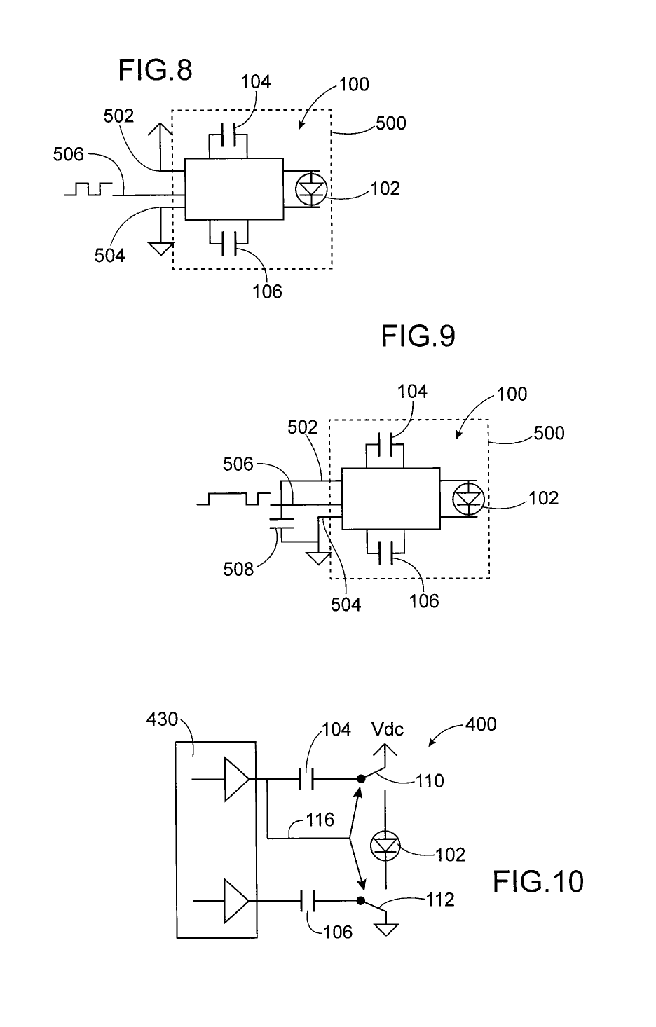

The voltage multiplier circuit 100, 200 or 300 described above may also be used to make a low voltage LED type device. Such a device 500 is shown in FIG. 8.

The LED 102, the two capacitors 104, 106 and the voltage multiplier circuit 100, 200 or 300 are integrated on a single support. The device 500 also comprises two power supply inputs 502 and 504 respectively coupled to a power supply potential Vdc and to the ground, and a third input 506 onto which the control signal outputted by an oscillator or a multi-vibrator is applied and intended to control the charge/discharge phases of the capacitors 104 and 106 of the voltage multiplier circuit.

By using capacitors 104 and 106 that charge quickly, which is achieved by using low resistance switches (for example equal to about 100 ohms) in the voltage multiplier circuit 100, with values equal to about 10 μF, the time constant τ of the equivalent RC dipole is equal to about 1 ms. By injecting a control signal in the form of a square signal with a frequency of about 1 kHz to the input of the device 500, the LED will flash very quickly to the extent that retinal persistence will give the appearance of a permanently lit LED.

Such a device 500 will advantageously be used with LEDs with high threshold voltages, for example blue or white LEDs, the device 500 being capable of making these LEDs operate with voltages less than these threshold voltages.

As a variant, the device 500 may also comprise the oscillator or the multi-vibrator integrated with the other components of the device 500.

In another variant shown in FIG. 9, a buffer capacitor 508 couples the power supply inputs 502 and 504 to each other. The value of the buffer capacitor 508 is greater than or equal to the values of the capacitors 104 and 106 of the voltage multiplier circuit. This additional capacitor 508 stores energy when the value of the control signal applied to the input 506 is “1” (for example +Vdc).

When the control signal changes to the value “0”, although the electrical power supply disappears for a short moment, the buffer capacitor 508 keeps the charge locally so that the assembly can function. Although not shown, there is a diode, for example a Schottky type diode, present between the capacitor 508 and the electrical power supply to limit or prevent current return from the buffer capacitor 508 to the power supply.

There are many possible applications for the previously described light devices 400 or 500:
signalling of obstacles at night or in the case of a power failure, particularly in homes;
insertion into tile joints on the floor, in walls, outdoors, etc.;
insertion into step nosers or corners of the steps in a staircase, in corridors or door sills, door handles, switches;
use in locations with generally poor lighting, for example a garage;
decorative use: clothes buttons, jewels (bracelets, necklaces), key holders, advertising articles, flashing glass, toys, Christmas decorations, etc.

The device 400 or 500 may comprise one or several LEDs and a low voltage microcontroller capable of controlling flashing of LEDs. Such a device 400 is shown in FIG. 10. Compared with the circuit 200 shown in FIG. 3, the device 400 comprises a microcontroller 430 replacing the inverters 202 and 204. The microcontroller 430 comprises two outputs coupled to the capacitors 104 and 106, the microcontroller 430 being programmed to output opposite signals on these two outputs. Operation of the device 400 is similar to the previously described circuits.

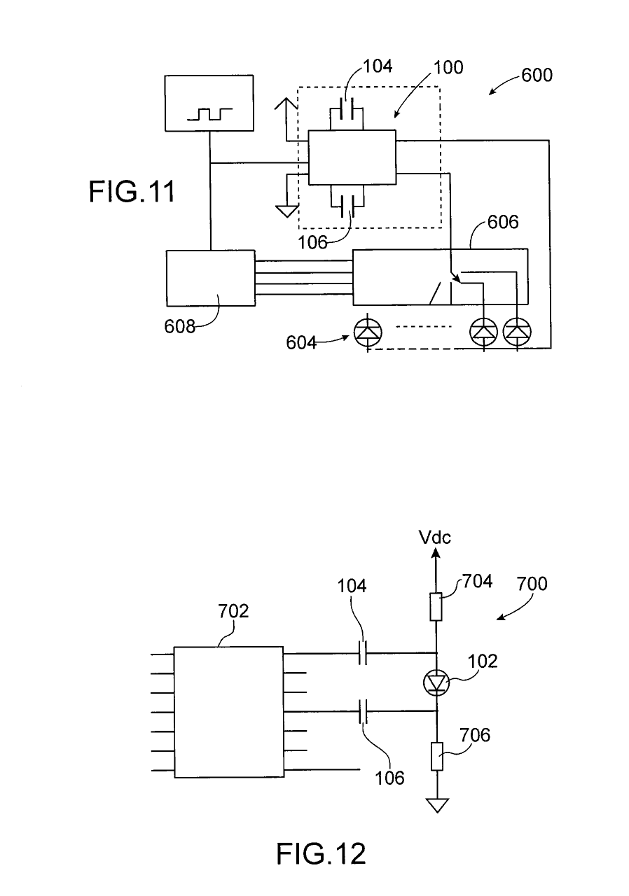

FIG. 11 shows another device 600 using the voltage multiplier circuit 100, 200 or 300, and making a running light type lighting with several LEDs.

The device 600 comprises the voltage multiplier circuit 100 coupled to an oscillator 602, for example similar to the oscillator previously described with reference to FIG. 7A. The device 600 also comprises several LEDs 604 intended to light up successively. To achieve this, the device 600 comprises an analogue multiplexer 606 capable of coupling one of the outputs of the voltage multiplier circuit 100 (for example corresponding to switch 112) to one of the terminals of the LEDs 604. The other output of the voltage multiplier circuit 100 (for example corresponding to the switch 110) is electrically coupled to all other terminals of the LEDs 604.

The multiplexer 606 is controlled through a binary counter 608. The binary counter 608 is also coupled to the oscillator 602, the control signal outputted by the oscillator 602 controlling the increment of the binary counter 608. The binary counter 608 may count on n bits, the device 600 possibly comprising 2ⁿ LEDs 604 in this case (the multiplexer also comprising 2ⁿ outputs so that each of the LEDs can be coupled to the voltage multiplier circuit 100).

A running light is thus made without significantly increasing the electrical consumption of the device in comparison with a device flashing a single LED, due to the lack of any amplifier.

In order to prevent any overvoltage at the transistors in the multiplexer 606, the current passing through the switching of the multiplexer 606 may be limited by adding a resistor, for example equal to about 1 kΩ, at the input of the multiplexer 606.

Such a limitation resistor may also be placed between LED 102 and the voltage multiplier circuit in all circuits and devices described above. Such a resistor can limit current peaks on the power supply.

Several voltage multiplier circuits like those described above may also be put in cascade, to obtain an output voltage equal to more than three times the input voltage.

However, in this case the values of capacitors in the different voltage multiplier stages are adapted so as to lose the minimum possible voltage during discharges in the subsequent multiplier stages (for example the capacitance values are equal to at least 100 μF in a first stage and a few μF in the next stage).

Referring now to FIG. 12 which represents a voltage multiplier circuit 700 according to another embodiment.

Compared to the multiplier circuit 100 described above, the first terminal of the capacitor 104 and the second terminal of the second capacitor 106 are electrically coupled to a microcontroller 702, for example of the MSP430 type. During the charging phase of the capacitors, the microcontroller 702 couples the first terminal of the first capacitor 104 to ground and the second terminal of the second capacitor 106 to the electrical potential +Vdc. Capacitors 104 and 106 are then electrically loaded through two resistors 704 and 706, the first resistor 704 being electrically coupled between the electrical potential +Vdc and the second terminal of the first capacitor 104, the second resistor 706 being electrically coupled between the first terminal of the second capacitor 106 and ground. The loading of the capacitors 104 and 106 occurs because the supply voltage +Vdc is less than the threshold voltage of the LED 102 which ensures during the charging phase of the capacitors 104 and 106 electrical insulation between the two resistors 704 and 706.

Once the capacitors 104 and 106 are loaded, the microcontroller 702 switches to a second state wherein the first terminal of the first capacitor 104 is electrically coupled to the potential +Vdc and wherein the second terminal of the second capacitor 106 is electrically coupled to the ground. Capacitors 104 and 106 then discharge through the LED 102 since the voltage at the second terminal of the first capacitor 104 increases and the voltage on the first terminal of the second capacitor 106 decreases due to charge pump, the voltage at the terminals of the LED 102 exceeding the threshold voltage thereof. This discharge through the LED 102 causes a lighting of the LED 102.

The lighting time of the LED 102 is around 20 microseconds, and the electrical charges provided by the capacitors 104 and 106 are around 2 microcoulomb (approximately 2 times 1 microfarad under 1 volt). This corresponds to a current through the LED 102 of about 100 mA: this is the reason of the light flash. The heating of the LED is negligible given the very short time of the light flash.

During the discharge of the capacitors 104 and 106 in the LED 102, as the voltage on the second terminal of the first capacitor 104 increases, a current flows through the resistor 704 (and also in the resistor 706). A voltage of about 1 volt on a resistance of about 47 kOhm corresponds to a current of 21 microamperes, which is negligible compared to the current of one hundred milliamperes which passes through the LED 102 when the discharge phase, and this is very acceptable as energy loss. It is also possible that the resistors 704 and 706 each have a value for example equal to about 100 kOhm, or any other suitable value (e.g. 10 kOhm).

In this other embodiment, the microcontroller 702 forms part of the coupling means, or coupler, of the multiplier circuit 700 and of the control means, or controller, of this circuit 700. The resistors 704 and 706 also form part of the coupling means, or coupler, of the circuit 700. Finally, the load formed by the LED 102 also forms a part of the coupling means, or coupler, and controlling means, or controller, of the circuit because the threshold voltage of this load determines when the LED 102 is conductive or not.

This embodiment has the advantage of being cheaper because it does not require a circuit to achieve the four switches 108, 110, 112 and 114. Moreover, it is possible to easily adjust the intensity of light flashes by programming the microcontroller 702 by adjusting the duration of the discharge phase of the capacitors.

It is also possible to increase the current passing through the capacitors 104 and 106 by placing several pins of the microcontroller 702 in parallel on each capacitor. This shortens the duration of the discharge phase of the capacitors. If two outputs of the microcontroller 702 are arranged in parallel on each capacitor, it is possible to divide this time by 2 for an approximately identical result in the first order, the maximum intensity obtained remaining within acceptable values.

1. A multiplier circuit for a voltage Vdc intended to be applied to at least one first input of the circuit, comprising at least:
a first capacitor and a second capacitor capable of storing electrical charges;
a coupler capable of electrically coupling, in a first state, a first terminal of each capacitor to a zero electrical potential and a second terminal of each capacitor to an electrical potential equal to Vdc, and capable of electrically coupling, in a second state, the first terminal of the first capacitor to the electrical potential Vdc, the second terminal of the second capacitor to the zero electrical potential, the second terminal of the first capacitor to a first output terminal of the circuit, and the first terminal of the second capacitor to a second output terminal of the circuit;
a controller capable of controlling the change from one state corresponding to the first or the second state, to another state corresponding to the second or first state respectively.

2. The multiplier circuit according to claim 1, in which the coupler comprises:
a first connector capable of electrically coupling, in the first state, the first terminal of the first capacitor to the zero electrical potential, or in the second state, to the electrical potential Vdc;
a second connector capable of electrically coupling, in the first state, the second terminal of the first capacitor to the electrical potential Vdc, or in the second state, to the first output terminal;
a third connector capable of electrically coupling, in the first state, the first terminal of the second capacitor to the zero electrical potential, or in the second state, to the second output terminal;
a fourth connector capable of electrically coupling, in the first state, the second terminal of the second capacitor to the electrical potential Vdc, or in the second state, to the zero electrical potential;
each of the first, second, third and fourth connectors comprising at least one switch or a CMOS inverter;
and in which the controller comprises a second input of the circuit intended to receive a control signal.

3. The multiplier circuit according to claim 2, in which the first connector comprises a CMOS inverter intended to be electrically powered by the voltage Vdc, the second input of the circuit is electrically coupled to an input of said CMOS inverter and an output of said CMOS inverter is electrically coupled to the first terminal of the first capacitor.

4. The multiplier circuit according to claim 3, in which the second and the third connectors each comprise a switch intended to be controlled by a signal outputted on the output of the CMOS inverter of the first connector.

5. The multiplier circuit according to claim 2, in which the fourth connector comprises a CMOS inverter intended to be electrically powered by the voltage Vdc, the first terminal of the first capacitor is electrically coupled to an input of the CMOS inverter of the fourth connector and an output of the CMOS inverter of the fourth connector is electrically coupled to the second terminal of the second capacitor.

6. The multiplier circuit according to claim 2, in which the second connector comprises a CMOS inverter comprising at least two MOS transistors, the sources of which are coupled to the electrical potential Vdc and to the first output terminal of the circuit, the second terminal of the first capacitor is electrically coupled to an output of the CMOS inverter (302) of the second connector and the first terminal of the first capacitor is electrically coupled to an input of the CMOS inverter of the second connector.

7. The multiplier circuit according to claim 2, in which the third connector comprises a CMOS inverter comprising at least two MOS transistors, the sources of which are electrically coupled to the zero electrical potential and to the second output terminal of the circuit, the first terminal of the second capacitor is electrically coupled to an output of the CMOS inverter of the third connector and the second terminal of the second capacitor is electrically coupled to an input of the CMOS inverter of the third connector.

8. The multiplier circuit according to claim 1, in which the coupler and the controller comprise:
a microcontroller capable of electrically coupling, in a first state, the first terminal of the first capacitor to the zero electrical potential, or in the second state, to the electrical potential Vdc, and capable of electrically coupling, in the first state, the second terminal of the second capacitor to the electrical potential Vdc, or in the second state, to the zero electrical potential;
at least one electrical load intended to be electrically powered by a voltage outputted between the first and the second output terminal of the multiplier circuit and having a threshold voltage intended to be less than the voltage Vdc;
a first electrical resistor electrically coupled between the electrical potential Vdc and the first output terminal of the multiplier circuit;
a second electrical resistor electrically coupled between the second output terminal of the multiplier circuit and the zero electrical potential.

9. An electronic device comprising at least:
a multiplier circuit according to claim 1;
at least one electrical load intended to be electrically powered by a voltage outputted between the first and the second output terminal of the multiplier circuit.

10. The electronic device according to claim 9, in which the electrical load comprises at least one LED.

11. The electronic device according to claim 9, also comprising:
an electrical power supply capable of generating an electrical voltage Vdc on an output;
a second controller capable of generating a control signal oscillating between two distinct values on an output;
in which the first input of the multiplier circuit is electrically coupled to the output of the electrical power supply, and in which the controller of the multiplier circuit is electrically coupled to the output of the second controller.

12. The electronic device according to claim 11, in which the electrical power supply comprises a photovoltaic energy converter coupled to at least one capacitor capable of storing energy outputted by the photovoltaic energy converter and supplying the electrical voltage Vdc to the terminals of said capacitor, or in which the electrical power supply comprises at least one battery or at least one capacitor capable of storing electrical charges outputted from the control signal.

13. The electronic device according to claim 11, in which the second controller comprises at least one oscillator or multi-vibrator, and is coupled to the electrical power supply and to the multiplier circuit.

14. The electronic device according to claim 9, in which the electrical load comprises a plurality of LEDs and at least one multiplexer capable of alternately coupling each LED with the first and second output terminals of the multiplier circuit.

15. A process for multiplying a Vdc voltage comprising at least the following steps:
a) coupling of a zero electrical potential to a first terminal of each of a first capacitor and a second capacitor capable of storing electrical charges, and an electrical potential equal to Vdc to a second terminal of each of the two capacitors, electrically charging the first capacitor and the second capacitor, and then
b) application of the electrical potential Vdc to the first terminal of the first capacitor, and a zero electrical potential to the second terminal of the second capacitor, an output voltage corresponding to the multiplied voltage Vdc being retrieved between the second terminal of the first capacitor and the first terminal of the second capacitor.

16. The process according to claim 15, in which steps a) and b) are repeated successively, the output voltage being applied to the terminals of at least one LED.
